(19) United States
(12) Patent Application Publication
(10) Pub. No.: US 2020/0346662 A1
(43) Pub. Date: Nov. 5, 2020

(54) INFORMATION PROCESSING APPARATUS, VEHICLE, MOBILE OBJECT, INFORMATION PROCESSING METHOD, AND PROGRAM

(71) Applicant: Sony Corporation, Tokyo (JP)

(72) Inventors: Hirotaka SUZUKI, Kanagawa (JP); Takuya NARIHIRA, Tokyo (JP); Akira NAKAMURA, Kanagawa (JP)

(73) Assignee: Sony Corporation, Tokyo (JP)

(21) Appl. No.: 16/760,463

(22) PCT Filed: Oct. 30, 2018
(86) PCT No.: PCT/JP2018/040234

§ 371 Date: Apr. 30, 2020

(30) Foreign Application Priority Data
Nov. 8, 2017 (JP) 2017-215837

(51) Int. Cl. B60W 60/00; G08G 1/01; G08G 1/0962; G08G 1/0967; G01C 21/34; G01C 21/00

(52) U.S. Cl. CPC B60W 60/0015; G08G 1/0112; G08G 1/0125; G08G 1/09626; G06K 9/00805; G01C 21/3453; G01C 21/3807; G01C 21/3407; G08G 1/096725

(57) ABSTRACT

An information processing apparatus according to an embodiment of the present technology includes a determination unit and a calculation unit. The determination unit determines whether an anticipation region exists on a planned route of a target mobile object that is a control target, the anticipation region being a region in which a specific traffic state is anticipated. With respect to the anticipation region determined to be on the planned route, the calculation unit calculates a movement plan of the target mobile object on the basis of movement information related to movement of another mobile object having passed through the anticipation region.

### TECHNICAL FIELD

The present technology relates to an information processing apparatus, a vehicle, a mobile object, an information processing method, and a program for controlling movement of the mobile object.

### BACKGROUND ART

Conventionally, technologies of automatically driving a mobile object such as a vehicle have been known. For example, Patent Literature 1 describes a vehicle control apparatus that achieves autonomous driving. A driving control unit of the vehicle control apparatus decides a driving route based on a driving lane, by using map information acquired from a map database on the basis of a destination input by a user and a current location detected by a GPS receiver. Acceleration, braking, steering, and the like are controlled on the basis of the driving route and information acquired by a sensor group installed in the vehicle. This makes it possible to achieve autonomous driving for driving a safe route (see paragraphs [0018], [0024], [0028] to [0030], FIG. 4, FIG. 5, and the like of Patent Literature 1).

### CITATION LIST

### Patent Literature

Patent Literature 1: WO 2016/194134

### DISCLOSURE OF INVENTION

### Technical Problem

As described above, in order to perform autonomous driving, various processes such as determining a traveling route, and acquiring and analyzing sensor information. There is a need for a technology that makes it possible to promptly determine a traveling direction, a traveling speed, and the like of a mobile object and to move the mobile object smoothly.

In view of the circumstances as described above, a purpose of the present technology is to provide an information processing apparatus, a vehicle, a mobile object, an information processing method, and a program that make it possible to promptly determine a traveling direction, a traveling speed, and the like of a mobile object and to move the mobile object smoothly.

### Solution to Problem

In order to achieve the above-described purpose, an information processing apparatus according to an embodiment of the present technology includes a determination unit and a calculation unit.

The determination unit determines whether an anticipation region exists on a planned route of a target mobile object that is a control target, the anticipation region being a region in which a specific traffic state is anticipated.

With respect to the anticipation region determined to be on the planned route, the calculation unit calculates a movement plan of the target mobile object on the basis of movement information related to movement of another mobile object having passed through the anticipation region.

In the information processing apparatus, it is determined whether an anticipation region exists on a planned route of a target mobile object that is a control target, the anticipation region being a region in which a specific traffic state is anticipated. When the anticipation region exists on the planned route, a movement plan of the target mobile object in the anticipation region is calculated on the basis of movement information of another mobile object having passed through the anticipation region. The use of the movement plan makes it possible to promptly determine a traveling direction, a traveling speed, and the like of the mobile object and to move the mobile object smoothly.

The specific traffic state may be a complicated traffic state.

The use of the movement plan makes it possible to move the target mobile object smoothly even when the target mobile object passes through a region in which a complicated traffic state is anticipated.

The movement plan may include a cost map related to a movement cost in the anticipation region, and a planned trajectory of the target mobile object that is calculated on the basis of the cost map.

This makes it possible to move the target mobile object, with the planned trajectory being set to be a target. Consequently, it is possible to promptly determine a traveling direction, a traveling speed, and the like of the mobile object.

The calculation unit may calculate the movement plan at least a predetermined time before an expected arrival time that is a time of arrival of the target mobile object at the anticipation region.

This makes it possible to calculate the movement plan at an appropriate timing before the mobile object arrives at the anticipation region, and to perform movement control without delay even in a complicated traffic state.

The information processing apparatus may further include an acquisition unit that acquires the movement information of the other mobile object on the basis of a passage time that is a time of passage of the other mobile object through the anticipation region, the movement information of the other mobile object being used to calculate the movement plan.

For example, this makes it possible to acquire movement information of another mobile object having passed through a passage region immediately before the target mobile object arrives at the passage region, and to improve the accuracy in a movement plan.

The movement information may include information regarding a passage point of the other mobile object in the anticipation region, and surrounding information of the other mobile object that is detected at a timing at which the other mobile object passes through the passage point.

This makes it possible to analyze a state and the like of an anticipation region in detail when another mobile object passes through the anticipation region. This results in being able to improve the accuracy in a movement plan.

The calculation unit may calculate a first map on the basis of the surrounding information of the other mobile object, the first map indicating a position of an obstacle in the anticipation region at the timing at which the other mobile object passes through the passage point.

This makes it possible to accurately extract information related to the presence or absence of an obstacle in an anticipation region and the position of the obstacle.

The calculation unit may calculate a second map on the basis of the first map, the second map indicating behavior of the obstacle for a period of time during which the other mobile object passes through the anticipation region.

This makes it possible to accurately extract information regarding whether an obstacle in an anticipation region remains stationary or is moving.

The calculation unit may calculate a cost map related to a movement cost in the anticipation region on the basis of the second map.

This makes it possible to calculate, in advance, a position and the like suitable for movement in an anticipation region, and to easily plan movement of the target mobile object.

The information processing apparatus may further include an update unit that updates the cost map on the basis of surrounding information of the target mobile object when the target mobile object enters the anticipation region.

This makes it possible to move the target mobile object safely depending on an actual traffic environment while suppressing processing necessary for movement control in an anticipation region.

On the basis of the planned trajectory, the update unit may set at least one of a detection range or an analysis range of the surrounding information of the target mobile object.

For example, it becomes possible to selectively detect surrounding information, for example, in a traveling direction of the target mobile object, and thus to shorten the time necessary to perform, for example, processes of detecting and analyzing the surrounding information.

The update unit may calculate a difference between the cost map before being updated and the cost map after being updated, and updates the planned trajectory of a region in which the difference has occurred.

By updating a planned trajectory focused on a location in which there is a change in a traffic state, as described above, it is possible to significantly shorten the processing time necessary for control of a traveling direction, a traveling speed, and the like of the mobile object.

On the basis of the difference, the update unit may determine whether to discard the planned trajectory, and when the update unit determines that the planned trajectory is to be discarded, the update unit may newly calculate a trajectory used to move the target mobile object.

This makes it possible to move the target mobile object safely.

The anticipation region may include at least one of an intersection, a junction, or a fork.

This makes it possible to shorten the time necessary to perform processing of calculating a final route even when the target mobile object moves in an intersection or the like in a complicated traffic state.

The anticipation region may include a tentative region that is a region in which a complicated traffic state has temporarily occurred.

This makes it possible to calculate a movement plan depending on an actual traffic environment even when congestion has temporarily occurred due to, for example, a traffic jam or an accident.

The tentative region may be a region in which the traffic density of the other mobile object is greater than a first threshold.

This makes it possible to accurately determine temporary congestion and the like.

The tentative region may be a region in which the time necessary to control movement of the other mobile object is greater than a second threshold.

This makes it possible to accurately determine temporary congestion and the like.

The determination unit may acquire anticipation region information related to the anticipation region from a server that is connected to each of the target mobile object and the other mobile object in such a manner that the server is capable of communicating with the target mobile object and the other mobile object via a network, and may determine whether the anticipation region exists on the planned route on the basis of the acquired anticipation region information.

For example, this makes it possible to perform, for example, management of anticipation region information using a server, and to accurately determine an anticipation region.

A vehicle according to an embodiment of the present technology includes a determination unit, a calculation unit, and a movement control unit.

The determination unit determines whether an anticipation region exists on a planned route of an own vehicle that is a control target, the anticipation region being a region in which a specific traffic state is anticipated.

With respect to the anticipation region determined to be on the planned route, the calculation unit calculates a movement plan of the own vehicle on the basis of movement information related to movement of another vehicle having passed through the anticipation region.

The movement control unit controls movement of the own vehicle in the anticipation region on the basis of the generated movement plan.

A mobile object according to an embodiment of the present technology includes a determination unit, a calculation unit, and a movement control unit.

The determination unit determines whether an anticipation region exists on a planned route of a mobile object that is a control target, the anticipation region being a region in which a specific traffic state is anticipated.

With respect to the anticipation region determined to be on the planned route, the calculation unit calculates a movement plan of the mobile object of the control target on the basis of movement information related to movement of another mobile object having passed through the anticipation region.

The movement control unit controls, on the basis of the generated movement plan, movement of the mobile object of the control target in the anticipation region.

An information processing method according to an embodiment of the present technology is an information processing method that is performed by a computer system, the information processing method including determining whether an anticipation region exists on a planned route of a target mobile object that is a control target, the anticipation region being a region in which a specific traffic state is anticipated.

With respect to the anticipation region determined to be on the planned route, a movement plan of the target mobile object is calculated on the basis of movement information related to movement of another mobile object having passed through the anticipation region.

A program according to an embodiment of the present technology causes a computer system to perform a process including:

determining whether an anticipation region exists on a planned route of a target mobile object that is a control target, the anticipation region being a region in which a specific traffic state is anticipated; and

calculating a movement plan of the target mobile object with respect to the anticipation region determined to be on the planned route, on the basis of movement information related to movement of another mobile object having passed through the anticipation region.

### Advantageous Effects of Invention

As described above, the present technology makes it possible to promptly determine a traveling direction, a traveling speed, and the like of a mobile object and to move the mobile object smoothly. Note that the effects described here are not necessarily limitative and any of the effects described in the present disclosure may be provided.

### BRIEF DESCRIPTION OF DRAWINGS

FIG. 1 is a schematic diagram illustrating a configuration example of a movement control system according to the present technology.

FIG. 2 is a set of external views illustrating a configuration example of an automobile.

FIG. 3 is a block diagram illustrating the configuration example of the automobile.

FIG. 4 is a schematic diagram illustrating an example of a navigation image.

FIG. 5 is a schematic diagram illustrating a configuration example of movement information of the automobile.

FIG. 6 is a schematic diagram illustrating an example of a passage trajectory of the automobile.

FIG. 7 is a schematic diagram illustrating a configuration example of a movement planning unit.

FIG. 8 is a flowchart illustrating an example of processing of calculating a movement plan in an anticipation region.

FIG. 9 is a schematic diagram illustrating an example of an occupancy map.

FIG. 10 is a schematic diagram illustrating an example of a probability map.

FIG. 11 is a schematic diagram illustrating an example of the probability map.

FIG. 12 is a schematic diagram illustrating an example of the probability map.

FIG. 13 is a schematic diagram illustrating an example of the synthesized probability maps.

FIG. 14 is a flowchart illustrating an example of an operation of a movement control unit in the anticipation region.

FIG. 15 is a schematic diagram illustrating an example of the movement plan.

FIG. 16 is a schematic diagram illustrating an example of the updated movement plan.

### MODE(S) FOR CARRYING OUT THE INVENTION

Hereinafter, embodiments of the present technology will be described with reference to the drawings.

### [Configuration of Movement Control System]

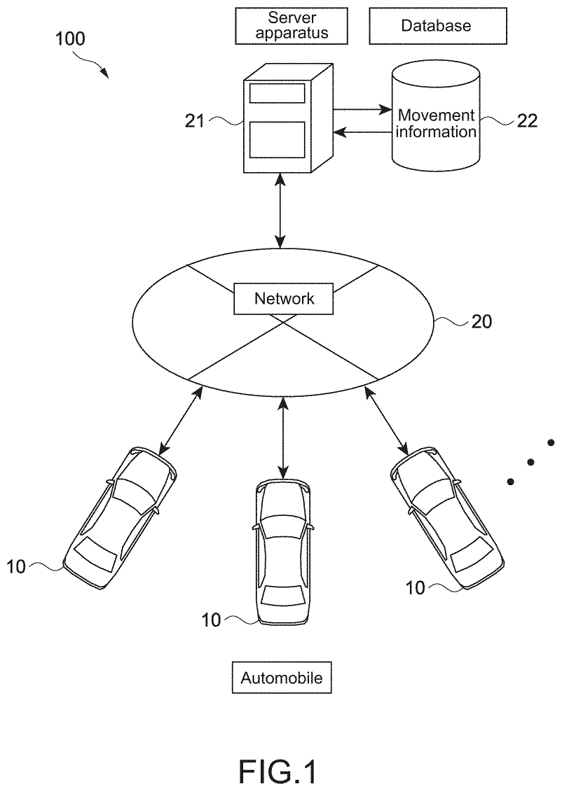

FIG. 1 is a schematic diagram illustrating a configuration example of a movement control system according to the present technology. A movement control system 100 includes a plurality of automobiles 10, a network 20, a server apparatus 21, and a database 22. Each of the plurality of automobiles 10 has an autonomous driving function capable of automatically driving to a destination. Note that the automobiles 10 are examples of a mobile object according to the present embodiment.

The plurality of automobiles 10 and the server apparatus 21 are connected in such a manner that they are capable of communicating with each other via the network 20. The server apparatus 21 is connected to the database 22 in such a manner that the server apparatus 21 is capable of accessing the database 22. For example, the server apparatus 21 is capable of recording information from the plurality of automobiles 10 on the database 22 and transmitting the information recorded on the database 22 to each of the automobiles 10. In the present embodiment, a so-called cloud service is provided by the network 20, the server apparatus 21, and the database 22. Therefore, it can also be said that the plurality of automobiles 10 is connected to a cloud network.

[Configuration of Automobile]

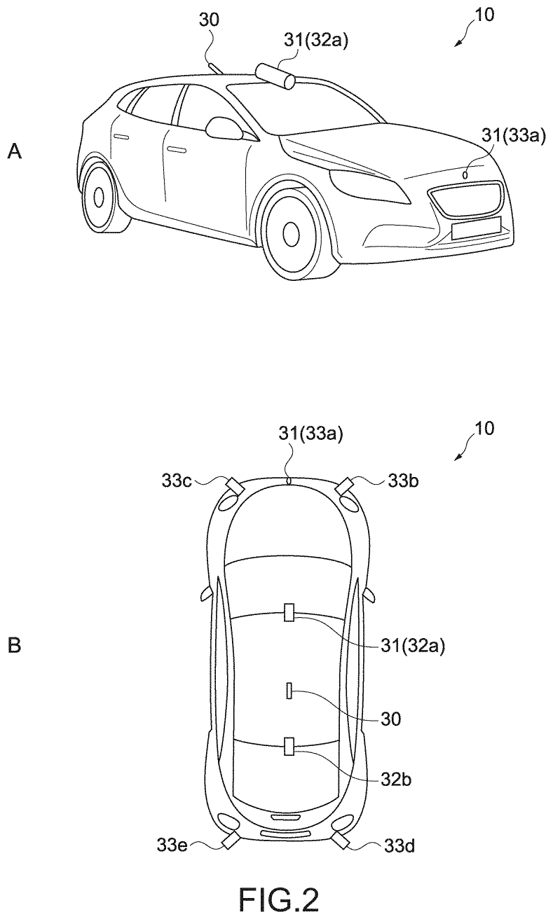

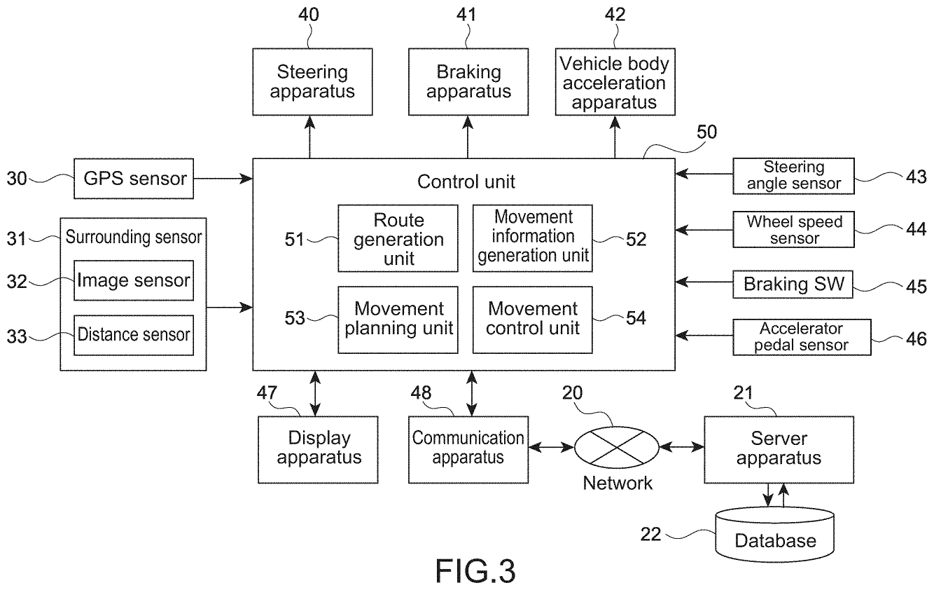

FIG. 2 is a set of external views illustrating a configuration example of the automobile 10. A of FIG. 2 is a perspective view illustrating the configuration example of the automobile 10. B of FIG. 2 is a schematic diagram obtained when the automobile 10 is viewed from above. FIG. 3 is a block diagram illustrating the configuration example of the automobile 10.

As illustrated in A and B of FIG. 2, the automobile 10 includes a GPS sensor 30 and a surrounding sensor 31. In addition, as illustrated in FIG. 3, the automobile 10 includes a steering apparatus 40, a braking apparatus 41, a vehicle body acceleration apparatus 42, a steering angle sensor 43, a wheel speed sensor 44, a braking switch 45, an accelerator pedal sensor 46, a display apparatus 47, a communication apparatus 48, and a control unit 50.

The GPS sensor 30 detects a current value of the automobile 10 on the earth by receiving a radio wave from a satellite. Information regarding the current value is typically detected as information regarding latitude and longitude of a location of the automobile 10. The information regarding the detected current value is output to the control unit.

The surrounding sensor 31 is a sensor that detects surrounding information of the automobile 10. Here, the surrounding information is information including image information and depth information of surroundings of the automobile 10. As illustrated in FIG. 3, the surrounding sensor 31 includes an image sensor 32 and a distance sensor 33.

The image sensor 32 captures an image of the surroundings of the automobile 10 at a predetermined frame rate, and detects the image information of the surroundings of the automobile 10. A and B of FIG. 2 illustrate a front camera 32a and a rear camera 32b as the image sensor 32. The front camera 32a captures an image of a field of view of a front side of the automobile 10. The rear camera 32b captures an image of a field of view of a rear side of the automobile 10.

For example, an RGB camera or the like is used as the image sensor 32. The RGB camera includes an image sensor such as a CCD or a CMOS. The present technology is not limited thereto. An image sensor or the like that detects infrared light or polarized light may be used as appropriate. By using the infrared light or polarized light, it is possible to generate image information or the like whose visibility is not so much changed even in the case where weather has changed, for example.

The distance sensor 33 is installed in such a manner that the distance sensor 33 faces toward the surroundings of the automobile 10, for example. The distance sensor 33 detects information related to distances to objects included in its detection range, and detects depth information of the surroundings of the automobile 10. A and B of FIG. 2 illustrate distance sensors 33a to 33e that are respectively installed on the front side, the right front side, the left front side, the right rear side, the left rear side of the automobile 10. For example, by using the distance sensor 33a installed on the front side of the automobile 10, it is possible to detect a distance to a vehicle running in front of the automobile 10, or the like.

For example, a Laser Imaging Detection and Ranging (LiDAR) sensor or the like is used as the distance sensor 33. By using the LiDAR sensor, it is possible to easily detect an image (depth image) with depth information or the like, for example. Alternatively, for example, a Time-of-Fright (TOF) depth sensor or the like may be used as the distance sensor 33. The type and the like of the distance sensor 33 are not limited. Any sensor using a rangefinder, a millimeter-wave radar, an infrared laser, or the like may be used.

The steering apparatus 40 typically includes a power steering apparatus, and transmits steering wheel operation performed by a driver to driving wheels. The braking apparatus 41 includes brake actuators attached to respective wheels and hydraulic circuits for actuating them, and controls braking force of the respective wheels. The vehicle body acceleration apparatus 42 includes a throttle valve, a fuel injector, and the like, and controls rotational acceleration of the driving wheels.

The steering angle sensor 43 detects change in steering angle of a steering wheel, directions of wheels depending on steering, and the like. The wheel speed sensor 44 is installed in some or all of the wheels and detects rotation speed and the like of the wheels. The accelerator pedal sensor 46 detects an operation amount or the like of an accelerator pedal. Note that the steering angle sensor 43, the wheel speed sensor 44, and the accelerator pedal sensor 46 are capable of detecting states of the steering wheel, the wheels, the accelerator pedal, and the like and outputting the states to the control unit 50 not only in the case where the driver drives the automobile 10 but also in the case of automatically driving the automobile 10.

The braking switch 45 is for detecting braking operation (depression of the brake pedal) performed by the driver, and is referred to at the time of ABS control or the like. In addition, any sensor that detects behavior of respective structural elements of the automobile 10 may be installed.

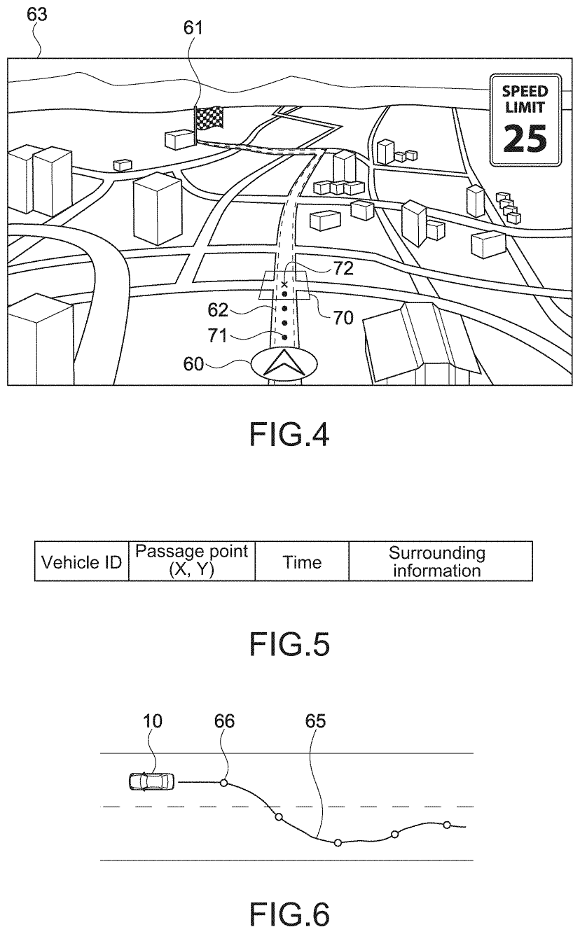

The display apparatus 47 includes a display unit that uses liquid crystals, electroluminescence (EL), or the like, for example. The display apparatus 47 displays a navigation image (see FIG. 4) that includes a planned route of the automobile 10 output from the control unit 50, a current location of the automobile 10, surrounding map information, and the like. This makes it possible to provide a car navigation service. Further, an apparatus for displaying an augmented reality (AR) image at a predetermined position such as a front windshield may be used. In addition, a specific configuration of the display apparatus 47, the type of displayed information, and the like are not limited.

The communication apparatus 48 performs wireless communication for connecting to the network 20. In addition, the communication apparatus 48 is configured to be capable of accessing the database 22 via the network 20 and the server apparatus 21. For example, the communication apparatus 48 performs download of data from the database 22, upload of data to the database 22, and the like as appropriate.

For example, a wireless communication module for a mobile object capable of wireless local area network (LAN) communication using Wi-Fi or the like, cellular communication such as Long-Term Evolution (LTE), or the like is used as the communication apparatus 48 as appropriate. In addition, a specific configuration of the communication apparatus 48 is not limited. For example, any communication apparatus 49 capable of connecting to the network 20 may be used.

The control unit 50 performs, for example, control of movement of the automobile 10 including the control unit 50. Therefore, a movement control target of the control unit 50 is the automobile 10 including the control unit 50. On the other hand, another automobile 10 that does not include the control unit 50 is another automobile that is different from the control target. In the present embodiment, the automobile 10 of the control target corresponds to a target mobile object that is the control target. In addition, the other automobile 10 corresponds to another mobile object that is different from the target mobile object.

The control unit 50 corresponds to an information processing apparatus according to the present embodiment, and includes hardware necessary for a computer such as a CPU, RAM, and ROM, for example. An information processing method according to the present technology is performed when the CPU loads a program into the RAM and executes the program. The program relates to the present technology and is recorded on the ROM in advance.

A specific configuration of the control unit 50 is not limited. For example, a programmable logic device (PLD) such as a field programmable gate array (FPGA), or another device such as an application specific integrated circuit (ASIC), may be used.

As illustrated in FIG. 3, the control unit 50 includes a route generation unit 51, a movement information generation unit 52, a movement planning unit 53, and a movement control unit 54. For example, each of the functional blocks is configured when the CPU of the control unit 50 executes a predetermined program.

The route generation unit 51 generates a planned route from a current location of the automobile 10 to a destination of the automobile 10. A planned route 62 is information indicating a way (a path) from the current location to the destination. Typically, the planned route 62 is information for designating roads included in map information. Accordingly, the planned route 62 designates roads or the like the automobile 10 should follow to get the destination from the current location.

The current location of the automobile 10 is current latitude and longitude of the automobile 10 detected by the GPS sensor 30, for example. In addition, for example, the driver or the like inputs the destination of the automobile 10 by using an input apparatus (not illustrated) or the like. The route generation unit 51 outputs information regarding a planned route to the movement planning unit 53. In addition, the route generation unit 51 generates a navigation image including the planned route, and outputs the generated navigation image to the display apparatus 47.

FIG. 4 is a schematic diagram illustrating an example of the navigation image. The example illustrated in FIG. 4 schematically illustrates a navigation image 63 including a current location 60, a destination 61, and a planned route 62 of the automobile 10, and map information of surroundings of the planned route 62. Note that the planned route 62 does not include information indicating where on a road to be taken the automobile 10 should travel.

The movement information generation unit 52 generates movement information related to movement of the automobile 10 including the movement information generation unit 52. In the present embodiment, information related to a passage trajectory through which the automobile 10 has passed is generated as the movement information.

FIG. 5 is a schematic diagram illustrating a configuration example of the movement information of the automobile 10. FIG. 6 is a schematic diagram illustrating an example of the passage trajectory of the automobile 10. FIG. 6 schematically illustrates a passage trajectory 65 of the automobile 10 having changed its lane on a road having two lanes each way. Next, the movement information (information related to the passage trajectory 65) of the automobile 10 will be specifically described with reference to FIGS. 5 and 6.

The automobile 10 detects a current location of the automobile 10 in operation (such as running or at a stop) at predetermined time intervals by using the GPS sensor 30 installed in the automobile 10. As illustrated in FIG. 6, a current location of the automobile 10 detected at each timing is a passage point 66 on the passage trajectory 65 of the automobile 10.

The movement information generation unit 52 generates, as the movement information, information in which a vehicle ID of the automobile 10 and information regarding the passage point 66 (latitude X and longitude Y) are associated. At this time, a time and date at which the automobile 10 passed through the passage point 66, and the like are recoded in the movement information.

In addition, the movement information generation unit 52 generates the movement information while associating the passage point 66 with its surrounding information (such as image information and depth information) detected at a timing at which the automobile 10 passes through the passage point 66. Therefore, as illustrated in FIG. 5, the movement information of the automobile 10 includes the vehicle ID of the automobile 10, the passage point 66, the time and date, the surrounding information of the passage point 66, and the like.

Note that the surrounding information is detected by the surrounding sensor 31 at a timing at which the automobile 10 passes through each passage point 66. For example, the image sensor such as the front camera 32a and the rear camera 32b detects image information of the front side, the rear side, and the like of the automobile 10 when the automobile 10 passes through the passage point 66. In addition, the distance sensor 33 such as the LiDAR sensor detects depth information of the surroundings of the automobile 10.

For example, a form such as movement information A=(vehicle ID, time and date, latitude and longitude of passage point 66, data of sensor 1, data of sensor 2, . . . , and data of sensor N) is used as the form of movement information. Note that data of the sensor 1 to the sensor N corresponds to data detected by the image sensor 32 or the distance sensor 33 mounted on each structural element of the automobile 10. As described above, by making the data form in which pieces of data are assembled for each passage point 66, it is possible to easily search for movement information A, for example. Alternatively, the form and the like of the movement information are not limited, and any form may be used.

The generated movement information of the automobile 10 is output to the communication apparatus 48, and is uploaded to the database 22 as appropriate. The timing and the like of the upload are not limited. For example, the movement information may be uploaded immediately after the automobile 10 passes through the passage point 66. Alternatively, for example, a set of pieces of movement information related to a plurality of passage points 66 may be uploaded depending on a communication situation or the like.

Consequently, the database 22 stores therein movement information from a plurality of automobiles 10. In other words, the database 22 collects information regarding passage trajectories 65 through which the respective automobiles 10 have passed. As a result, for example, it is possible to search for an automobile 10 (a vehicle ID) or the like having passed through a certain region by searching for movement information in which the certain region includes a passage point 66. In addition, it is also possible to search for an automobile 10 or the like having passed through a target region during a desired period of time by searching for movement information with the time and date being specified.

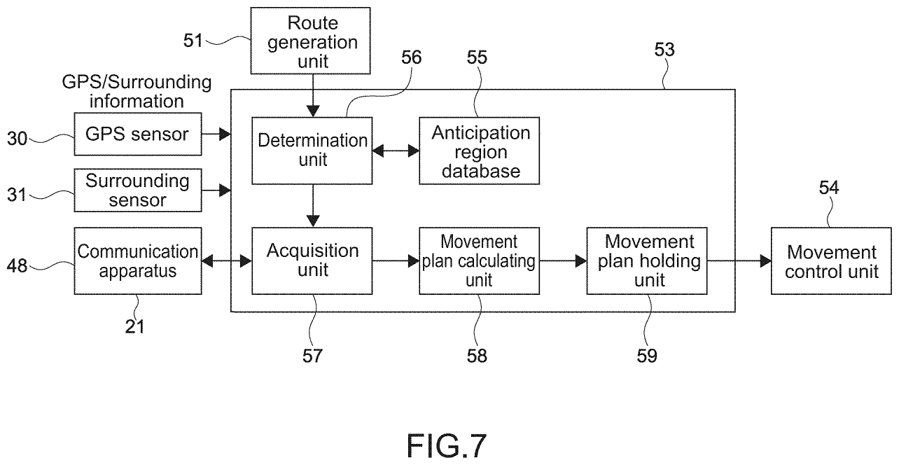

FIG. 7 is a schematic diagram illustrating a configuration example of the movement planning unit 53. The movement planning unit 53 includes an anticipation region database 55, a determination unit 56, an acquisition unit 57, a movement plan calculating unit 58, and a movement plan holding unit 59.

The anticipation region database 55 is a database that stores therein anticipation region information related to an anticipation region in which a specific traffic state is anticipated. For example, a traffic state anticipated upon controlling movement of the automobile 10 is set to be the specific traffic state as appropriate. In the present embodiment, a complicated traffic state is set to be the specific traffic state. Here, the complicated traffic state is, for example, a state in which the automobiles 10, bicycles, pedestrians, and the like come and go in a mixed manner.

For example, as illustrated in FIG. 4, there is a good possibility that the complicated traffic state will occur at, for example, an intersection at which roads intersect, since a plurality of automobiles 10, a plurality of pedestrians, and the like move in various directions. In other words, the anticipation region can also be considered a region in which there is a possibility of encountering a complicated traffic situation (traffic state). Information related to a location (anticipation region) in which such a state is anticipated is stored in the anticipation region database 55 as the anticipation region information. Note that FIG. 4 schematically illustrates a range that indicates an anticipation region 70.

Examples of the anticipation region 70 include an intersection, a junction, and a fork. For example, position data and region data are stored in association with each other as anticipation region information related to an intersection, the position data being data at a center position of the intersection, the region data representing the size, the shape, and the like of the intersection. Further, with respect to a junction (a fork), position data representing the position of the junction (the fork), and region data representing the region of the junction (the fork) are also stored.

Further, examples of the anticipation region 70 include a tentative region that is a region in which a complicated traffic state has temporarily occurred. The tentative region is a region in which traffic is temporarily busy due to, for example, a traffic jam or an accident. For example, position data and region data related to a tentative region detected by the server apparatus 21 are stored in the anticipation region database 55. Note that information related to a tentative region is temporary information, and is deleted from the anticipation region database 55 when the traffic state in the tentative region is improved. The tentative region will be described later in detail.

Moreover, the type and the like of the anticipation region 70 are not limited. For example, the anticipation region 70 may be set only for an intersection or the like at which a plurality of lanes having a lot of traffic intersects, where examples of the plurality of lanes having a lot of traffic include two lanes each way and three lanes each way. For example, information related to, for example, a high-accident area or an area in which a traffic jam occurs frequently, or information related to, for example, an area under construction or a lane-drop area may be stored as the anticipation region information. Further, the form and the like of the anticipation region information are not limited, and, for example, any form that makes it possible to identify the position of each anticipation region 70 may be used.

The determination unit 56 determines whether the anticipation region 70 in which a specific traffic state (a complicated traffic state) is anticipated exists on the planned route 62 of the automobile 10 of a control target. In the present embodiment, it is determined whether the anticipation region 70 (anticipation region information) stored in the anticipation region database 55 exists on the planned route 62 of the automobile 10.

The acquisition unit 57 acquires movement information related to movement of another automobile 10 that is different from the automobile 10 of the control target. Specifically, the acquisition unit 57 accesses the database 22 via the communication apparatus 48, and acquires movement information of the other automobile 10 stored in the database 22.

In the present embodiment, movement information of another automobile 10 having passed through the anticipation region 70 determined to be on the planned route 62, is acquired on the basis of position data and region data of the anticipation region 70. Thus, the movement information acquired by the acquisition unit 57 includes information regarding a passage point 66 of the other automobile 10 in the anticipation region 70, and surrounding information of the other automobile 10 that is detected at a timing at which the other automobile 10 passes through the passage point 66.

With respect to the anticipation region 70 determined to be on the planned route 62, the movement plan calculating unit 58 calculates a movement plan of the automobile 10 of the control target on the basis of the movement information related to movement of the other automobile 10 having passed through the anticipation region 70. Thus, a plan (a movement plan) for moving the anticipation region 70 to the automobile 10 of the control target can be calculated in advance before the automobile 10 of the control target arrives at the anticipation region 70.

Note that, when it has been determined that a plurality of anticipation regions 70 exists on the planned route 62, for example, movement information of another automobile 10 is acquired and a movement plan of the other automobile 10 is calculated with respect to a nearest anticipation region 70 that is situated closest to the current location 60 of the automobile 10 of the control target. After that, movement information of another automobile 10 is acquired and a movement plan of the other automobile 10 is calculated with respect to the second closest anticipation region 70. In other words, respective calculations of a movement plan with respect to the plurality of anticipation regions 70 existing from the current location 60 to the destination 61, are performed in series. Of course, the method is not limited thereto, and respective series of acquisition of movement information and calculation of a movement plan of another automobile 10 with respect to the plurality of anticipation regions 70, may be performed in parallel.

In the present embodiment, a movement plan of the automobile 10 is calculated at least a predetermined time before an expected arrival time at which the automobile 10 arrives at the anticipation region 70. The predetermined time is typically set as appropriate in a range of from a few seconds to a few minutes in such a manner that the movement plan is calculated immediately before the automobile 10 enters the anticipation region 70. This makes it possible to calculate a movement plan on the basis of information regarding the anticipation region 70 immediately before the entrance of the automobile 10 into the anticipation region 70. Note that a specific value of the predetermined time is not limited, and may be set as appropriate depending on the computational capability of the control unit 50, a traffic state, and the like.

A cost map related to a movement cost in the anticipation region 70 is calculated as the movement plan. In the cost map, a high movement cost is set for a region including, for example, an obstacle such as a traffic barrier or a median strip, a region where it is difficult to travel, and the like. Conversely, a low movement cost is set for a region where it is possible to travel along a middle of a lane or the like.

Further, a planned trajectory of the automobile 10 is calculated as the movement plan on the basis of the cost map described above. Here, the planned trajectory is, for example, information that specifies a position that is a target of movement of the automobile 10 in the anticipation region 70. For example, the use of the planned trajectory makes it possible to specify a position or the like to be passed through in an intersection at the time of passing through the intersection. Thus, the planned trajectory can also be considered information in which it is possible to specify a position more precisely than the case of the planned route 62 described above. A method of generating a cost map and a planned trajectory will be described later in detail.

The movement plan holding unit 59 temporarily holds (stores) the calculated movement plan in a storage element such as a memory. Further, the movement plan holding unit 59 outputs the movement plan at a timing at which the automobile 10 arrives at the anticipation region 70. Note that the configuration is not limited to holding a movement plan in the automobile 10, and, for example, a configuration of storing a movement plan in the database 22 via the network 20 may be adopted. In this case, the movement plan is downloaded as appropriate before the automobile 10 arrives at the anticipation region 70.

Returning to FIG. 3, the movement control unit 54 controls movement of the automobile 10. For example, the control unit 50 achieves autonomous driving including autonomous obstacle avoidance by proactively controlling the steering apparatus 40, the braking apparatus 41, and the vehicle body acceleration apparatus 42 on the basis of surrounding information or the like of the automobile 10 that is detected by the surrounding sensor 31. Note that the control unit 50 may of course control the steering apparatus 40, the braking apparatus 41, and the vehicle body acceleration apparatus 42 individually, or the control unit 50 may perform cooperative control of at least two out of these apparatuses. This makes it possible to control the automobile 10 in such a manner that the automobile 10 has a desired posture at the time of steering (turning), braking, acceleration, or the like.

Further, the movement control unit 54 controls movement of the automobile 10 in the anticipation region 70 on the basis of a movement plan. In other words, it can also be said that control of movement of the automobile 10 using a movement plan (a cost map and a planned trajectory) is started when the automobile 10 arrives at the anticipation region 70.

In the present embodiment, the movement control unit 54 updates a cost map on the basis of surrounding information of the automobile 10 when the automobile 10 enters the anticipation region 70. Then, autonomous driving is performed in the anticipation region 70 using the updated cost map. In the present embodiment, the movement control unit 54 serves as an update unit that updates a cost map. Note that, for example, autonomous driving using a movement plan is performed until the passage of the automobile 10 through the anticipation region 70 is completed, and then normal autonomous driving is performed.

[Processing of Calculating Movement Plan]

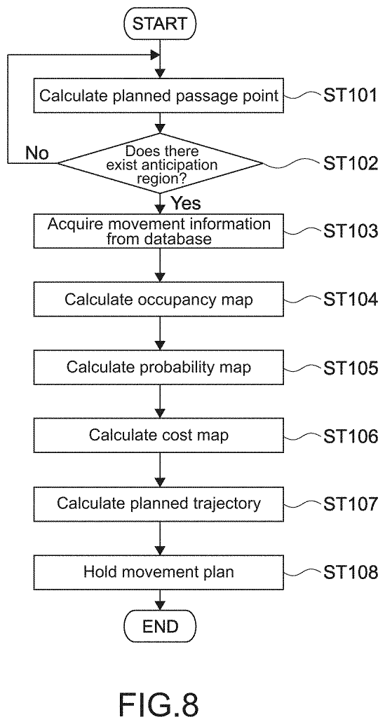

FIG. 8 is a flowchart illustrating an example of processing of calculating a movement plan in the anticipation region 70. Hereinafter, the automobile 10 of a movement control target may be referred to as an own vehicle 11, and the other automobile 10 may be referred to as another vehicle 12.

First, it is determined, by the determination unit 56, whether the anticipation region 70 in which a complicated traffic state is anticipated exists on the planned route 62 of the own vehicle 11 (Steps 101 and 102). Note that processing of determination regarding the anticipation region 70 is constantly performed during autonomous driving of the own vehicle 11.

In Step 101, a planned passage point on the planned route 62 is calculated by the determination unit 56. FIG. 4 schematically illustrates a calculated planned passage point 71. The planned passage points 71 are points equally spaced at predetermined intervals along the planned route 62 from the current location 60 of the own vehicle 11. In Step 101, which is the first step, the position (latitude and longitude) of the planned passage point 71 situated away from the current location 60 by the predetermined interval is calculated. Note that, for example, spacing of the planned passage point 71 (the predetermined interval) is set as appropriate in such a manner that it becomes possible to detect the anticipation region 70 with a desired degree of accuracy.

In Step 102, it is determined whether the anticipation region 70 exists around the planned passage point 71. For example, the anticipation region 70 within an acceptable range (for example, a circle of a radius of 50 m) centered on the planned passage point 71 is searched for using pieces of position data of the respective anticipation regions 70 that are stored in the anticipation region database 55, and it is determined whether the anticipation region 70 exists around the planned passage point 71. Moreover, a specific method of performing the determination processing and the like are not limited. For example, it may be determined, on the basis of region data of the anticipation region 70, whether there exists the anticipation region 70 including the planned passage point 71.

When there does not exist the anticipation region 70, that is, when a satisfactory anticipation region 70 has not been retrieved (No in Step 102), the process returns to Step 101, a position of a next planned passage point 71 is calculated, and determination regarding the next planned passage point 71 is performed.

When there exists the anticipation region 70, that is, when the satisfactory anticipation region 70 has been retrieved (Yes in Step 102), anticipation region information (position data and region data) of the retrieved anticipation region 70 is output to the acquisition unit 57. For example, in the case of FIG. 4, it is determined that the anticipation region 70 (an intersection 72) exists around the fourth planned passage point 71 from the current location 60. Anticipation region information related to a center position and a range of this intersection 72 is output to the acquisition unit 57.

Movement information of another vehicle 12 having passed through the anticipation region 70 is acquired by the acquisition unit 57 (Step 103). In the present embodiment, movement information of another vehicle 12 that is used to calculate a movement plan is acquired on the basis of a passage time that is a time of passage of the other vehicle 12 through the anticipation region 70.

For example, movement information of another vehicle 12 having passed through the anticipation region 70 in a threshold period of time before a predetermined timing (a point in time), is acquired. For example, the predetermined timing is set as appropriate in such a manner that calculation of a movement plan is completed at least a predetermined time before a time at which the own vehicle 11 arrives at the anticipation region 70 (an expected arrival time). Further, for example, the threshold period of time is set in a range of about a few minutes to a few tens of minutes (for example, 30 minutes) in such a manner that a movement plan can be calculated with a desired degree of accuracy.

For example, by setting the predetermined timing and the threshold period of time as appropriate, it is possible to extract movement information of another vehicle 12 having passed through the anticipation region 70 substantially immediately before the own vehicle 11 arrives at the anticipation region 70. Accordingly, surrounding information and the like of the other vehicle 12 in which a substantially last-minute state of the anticipation region 70 is recorded, is acquired. This results in being able to sufficiently increase a level of consistency between a movement plan and a state when the own vehicle 11 arrives at the anticipation region 70.

Note that the predetermined timing does not necessarily coincide with a time at which the anticipation region 70 has been determined to be on the planned route 62. For example, when the anticipation region 70 is situated sufficiently away from the own vehicle 11, processing of acquiring movement information of another vehicle 12 after the own vehicle gets close to the anticipation region 70, is performed. Specific values of the predetermined timing and the threshold period of time, specific methods for setting the predetermined timing and the threshold period of time, and the like are not limited, and, for example, they may be set as appropriate depending on the communication environment, the processing capacity, or the like.

For example, the acquisition unit 57 transmits, to the server apparatus 21 and via the communication apparatus 48, an instruction to search for movement information of another vehicle 12 having passed through the anticipation region 70 for the threshold period of time (a target period of time) before the predetermined timing. First, the server apparatus 21 performs filtering using a passage time, and extracts, from the database 22, movement information of another vehicle 12 that has been generated for the target period of time. Next, the server apparatus 21 extracts another vehicle 12 having a passage point 66 that is included in the anticipation region 70. Accordingly, movement information of another vehicle 12 that has been generated for the target period of time and has a passage point 66 that is included in the anticipation region 70, is retrieved. The retrieved movement information of the other vehicle 12 is transmitted to the acquisition unit 57 (the communication apparatus 48). Moreover, any method may be used to acquire movement information.

An occupancy map of an obstacle in the anticipation region 70 is calculated by the movement plan calculating unit 58 on the basis of surrounding information of the other vehicle 12 (Step 104). The occupancy map is a map that indicates a position of an obstacle existing in the anticipation region 70 at a certain moment. Here, the occupancy map indicating a position of an obstacle in the anticipation region 70 at a timing at which the other vehicle 12 passes through the passage point 66, is calculated. In the present embodiment, the occupancy map corresponds to a first map.

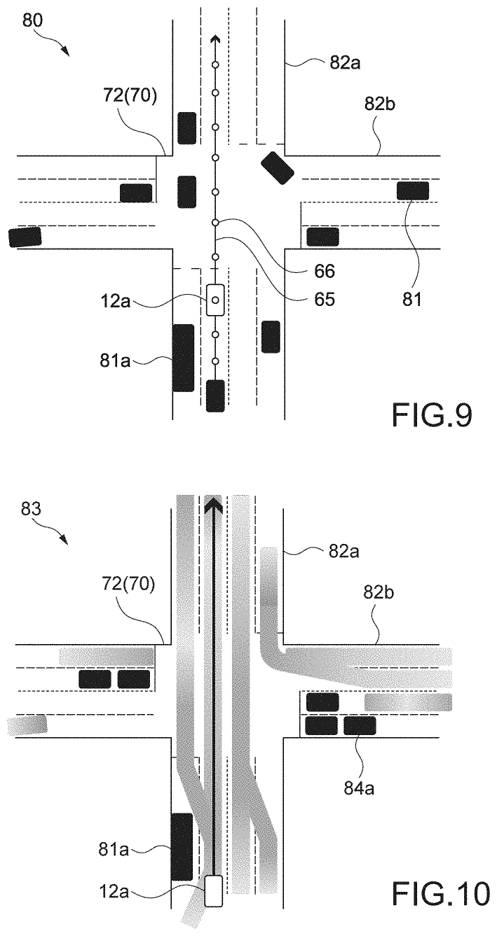

FIG. 9 is a schematic diagram illustrating an example of an occupancy map. FIG. 9 schematically illustrates an occupancy map 80 that is calculated on the basis of surrounding information of another vehicle 12a having passed through the intersection 72 that is the anticipation region 70, a passage trajectory 65 of the other vehicle 12a (an arrow), and the passage points 66 (white circles). Further, obstacles 81 (such as vehicles) existing in the intersection 72 are illustrated as black regions. A road extending in the up-down direction and a road extending in the left-right direction in the figure are hereinafter respectively referred to as a first road 82a and a second road 82b. As illustrated in FIG. 9, the other vehicle 12a goes straight ahead across the intersection 72 from below upward along the first road 82a.

For each passage point 66 through which the other vehicle 12a has passed, the occupancy map 80 is generated on the basis of surrounding information detected at the passage point 66. FIG. 9 illustrates an example of the occupancy map 80 at the moment of the other vehicle 12a having passed through a passage point 66a from among a plurality of passage points 66. The occupancy map 80 is generated for each of the other passage points 66. In other words, it can also be said that the occupancy map 80 corresponding to each temporal stage for a period of time during which the other vehicle 12a has passed through the intersection 72, is generated. Further, similar processing is performed with respect to other vehicles 12 different from the other vehicle 12a. Thus, in Step 104, a plurality of occupancy maps 80 is generated correspondingly to the number of passage points 66 for each another vehicle 12 having passed through the intersection 72 (the anticipation region 70).

The occupancy map 80 is calculated by recognizing the surrounding environment of the other vehicle 12a on the basis of the surrounding information and by understanding the environment of the anticipation region 70. For example, the position and the like of the obstacle 81 are detected using depth information (for example, information regarding a LiDAR point cloud that is detected by a LiDAR sensor) that is included in the surrounding information. Processing of detecting the position of the obstacle 81 is not limited, and, for example, a method of determining the obstacle 81 using three-dimensional features, or the like is used as appropriate.

Further, for example, a pedestrian, a bicycle, a vehicle, and the like (the obstacle 81) are detected using image information that is included in surrounding information. The detection of a pedestrian and the like may be performed using any image analysis technique such as template matching or image scanning. The detected obstacle is arranged on a map depending on the detection position, and the occupancy map 80 of the intersection 72 (the anticipation region 70) is generated. For example, 1 and 0 are respectively given as values (map values) respectively corresponding to a region in which there exists an obstacle and a region in which there does not exist an obstacle, and the binarized occupancy map 80 is generated. Moreover, a specific form and the like of the occupancy map 80 are not limited.

A probability map of the obstacle 81 in the anticipation region 70 is calculated by the movement plan calculating unit 58 on the basis of the occupancy map 80 (Step 105). The probability map is, for example, a map (a probabilistically representing occupancy map) that probabilistically represents a rate of existence of the obstacle 81 for a certain period of time. In the present embodiment, the probability map corresponds to a second map.

In the probability map, for example, the rate (probability) of existence of the obstacle 81 is set high at a point at which the obstacle 81 remained stationary. On the other hand, the rate (probability) of existence of the obstacle 81 is set low at a point through which the obstacle 81 has passed. Thus, the probability map can also be considered a map that represents the behavior of the obstacle 81 such as whether the obstacle 81 was moving or remained stationary for a certain period of time.

In the present embodiment, a probability map 83 is calculated that represents the behavior of the obstacle 81 for a period of time during which another vehicle 12 passes through the anticipation region 70. Thus, processing of calculating a probability map is performed for each another vehicle 12.

For example, the occupancy maps 80 generated at the respective passage points 66 illustrated in FIG. 9 are superimposed on one another with respect to the other vehicle 12a. Specifically, processing of summing up map values (1 or 0) given to the respective points is performed. The summed-up map values are normalized by a value obtained by the summing up being divided by the number of passage points 66. Note that the method of generating a probability map on the basis of the occupancy map 80 is not limited.

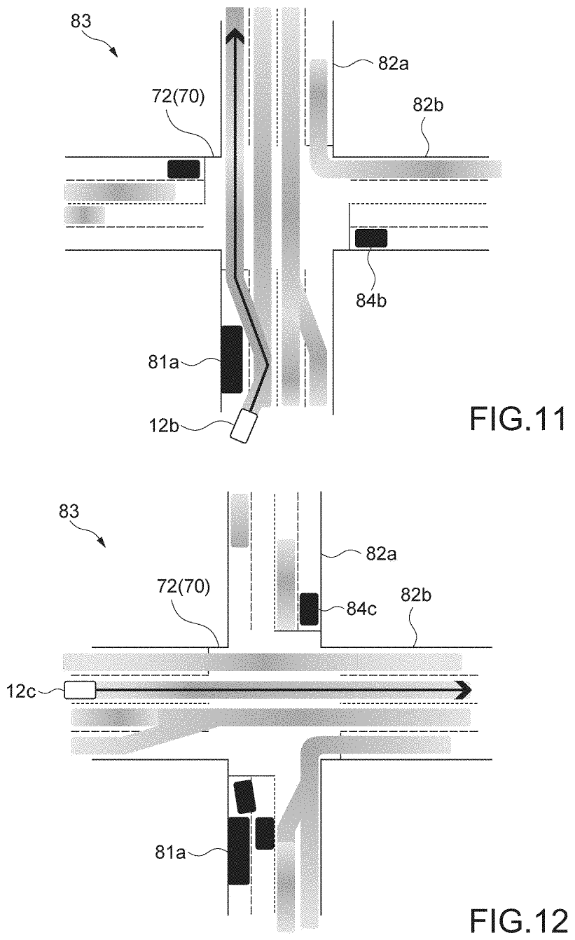

FIGS. 10 to 12 are schematic diagrams respectively illustrating examples of a probability map. FIG. 10 illustrates the probability map 83 described in FIG. 9 that represents the behavior of the obstacle 81 for the period of time during which the other vehicle 12a passes through the anticipation region 70. Further, FIG. 11 illustrates the probability map 83 representing the behavior of the obstacle 81 for a period of time during which another vehicle 12b passes through the anticipation region 70, and FIG. 12 illustrates the probability map 83 representing the behavior of the obstacle 81 for a period of time during which another vehicle 12c passes through the anticipation region 70. Note that, in FIGS. 10 to 12, a region in a darker gray is a region with a higher probability of existence of an obstacle.

As illustrated in FIG. 10, for a period of time during which the other vehicle 12a goes straight ahead to pass through the intersection 72 along the first road 82a, a vehicle 84a that enters the intersection 72 from the second road 82b stops at a red light. Thus, in the probability map 83, the rate of existence of the vehicle 84a (the obstacle 81) stopping at a red light is represented by a large probability value (black). On the other hand, a region in which there does not exist the obstacle 81 such as a vehicle has a small probability value (white).

Further, in a region through which the obstacle 81 such as a vehicle has moved, the rate of existence of the obstacle 81 is represented by a medium probability value (grayscale) depending on, for example, the movement rate of the obstacle 81. Thus, for example, a region through which the obstacle 81 has passed rapidly has a small probability value and is represented in a light gray, and a region through which the obstacle 81 has passed slowly has a large probability value and is represented in a dark gray.

As illustrated in FIG. 11, the other vehicle 12b avoids an obstacle 81a that exists on the lower side of the first road 82a, and goes straight ahead across the intersection 72 along the first road 82a. Note that the timing at which the other vehicle 12b passes through the intersection 72 is different from the timing at which the other vehicle 12a passes through the intersection 72. Thus, the positions of a vehicle 84b that stops at a red light are different in FIGS. 10 and 11.

As illustrated in FIG. 12, the other vehicle 12c enters the intersection 72 from the left in the figure, and goes straight ahead across the intersection 72 along the second road 82b. In this case, a vehicle 84c that enters the intersection 72 from the first road 82a stops at a red light. As described above, the respective probability maps 83 of another vehicle 12 passing through the intersection 72 (anticipation region) from various directions at various timings are calculated. Further, the calculation of the probability map 83 makes it possible to easily distinguish a dynamic obstacle 81 that is moving at each timing from a static obstacle 81 that remains stationary at the timing.

A cost map related to a movement cost in the anticipation region 70 is calculated by the movement plan calculating unit 58 on the basis of the probability map 83 (Step 105). In the present embodiment, synthesis processing of superimposing the probability maps 83 generated in Step 104 over one another is performed. Then, a cost map is calculated by converting the synthesized probability values into a movement cost as appropriate.

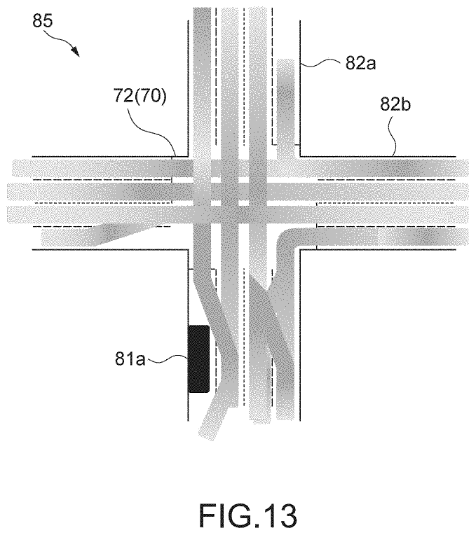

FIG. 13 is a schematic diagram illustrating an example of the synthesized probability maps 83. FIG. 13 illustrates a synthesis map 85 obtained by synthesizing the probability maps 83, as described in FIGS. 10 to 12. For example, processing that includes summing up probability values of respective points on a map and normalizing the summed-up probability values, is performed as processing of synthesizing the probability maps 83.

As illustrated in FIG. 13, the probability value of a vehicle or the like that stopped due to a red light is made smaller by synthesizing the respective probability maps 83. On the other hand, the probability value of a stationary obstacle 81 (the obstacle 81a on the lower side of the first road 82a) included in common in the respective probability maps 83 remains large. For example, a parked vehicle or the like that is parked on a shoulder of a road is more likely to remain the obstacle 81 having a large probability value in the synthesis map 85.

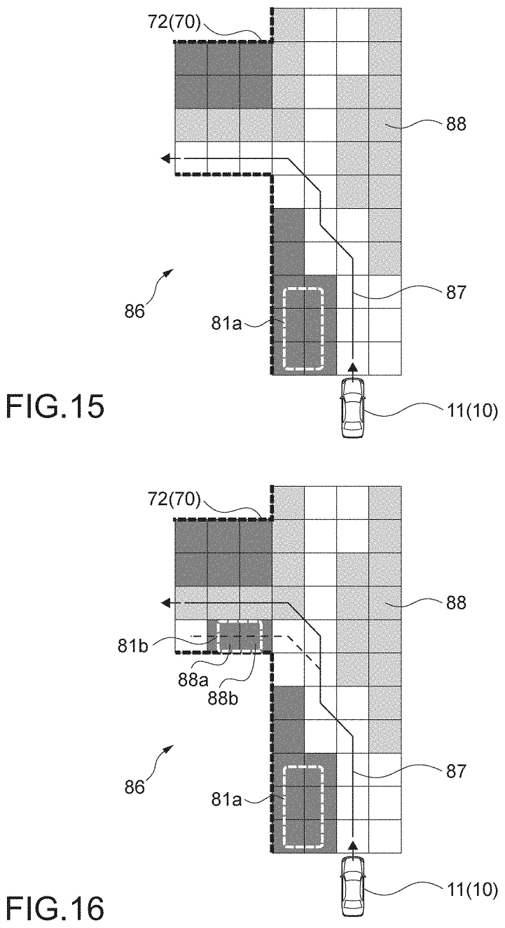

A probability value of the synthesis map 85 is converted into a movement cost as appropriate and a cost map is calculated. For example, the synthesis map 85 is divided into grid cells spaced at predetermined intervals, and an average of probability values in each grid cell is converted into a movement cost (see FIG. 15).

For example, a movement cost of a grid cell having a large probability value is set high, and a movement cost of a point having a small probability value is set low. This makes it possible to easily calculate a cost map of the intersection 72 that includes information of the obstacle 81 such as a parked vehicle. Further, for example, processing of setting a movement cost of a region (a grayscale region) in which the obstacle 81 has moved relatively low, may be performed. Accordingly, a movement cost of a region, in the intersection 72, in which movement occurs frequently, can be set low. Moreover, a method of calculating a cost map is not limited.

A planned trajectory of the automobile 10 in the anticipation region 70 is calculated on the basis of the cost map (Step 107). For example, a trajectory for passing through the anticipation region 70 along the planned route 62 of the own vehicle 11 is calculated. Specifically, a shortest trajectory from a side to enter the anticipation region 70 to a side to exit from the anticipation region 70 is searched for on the cost map. A result of this search is a planned trajectory of the own vehicle 11 for passing through the anticipation region 70. A method of searching for a shortest trajectory is not limited, and, for example, a search algorithm such as an A*algorithm, or a search using machine learning or the like may be used as appropriate.

A movement plan that includes a cost map and a planned trajectory is held by the movement plan holding unit 59 (Step 108). For example, the movement plan is stored in a memory or the like until the own vehicle 11 arrives at the anticipation region 70. Further, for example, on the basis of the current location 60 of the own vehicle 11, the movement plan holding unit 59 outputs the held movement plan (the cost map and the planned trajectory) to the movement control unit 54 in synchronization with a timing at which the own vehicle 11 enters the anticipation region 70.

[Control of Movement of Automobile]

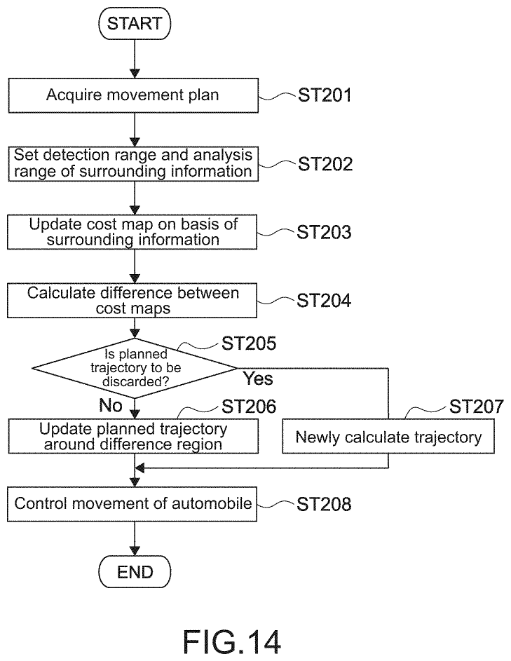

FIG. 14 is a flowchart illustrating an example of an operation of the movement control unit 54 in the anticipation region 70. FIG. 15 is a schematic diagram illustrating an example of a movement plan. FIG. 15 schematically illustrates a cost map 86 of the intersection 72 and a planned trajectory 87 of the own vehicle 11. Note that the own vehicle 11 enters the intersection 72 from the lower side in the figure to turn left. An example of controlling movement at the intersection 72 is described below with reference to FIGS. 14 and 15.

A movement plan is acquired by the movement control unit 54 (Step 201). In the present embodiment, the cost map 86 and planned trajectory 87 calculated in advance are acquired at a timing at which the own vehicle 11 enters the anticipation region 70.

A detection range and an analysis range of surrounding information of the own vehicle 11 are set on the basis of the planned trajectory 87 (Step 202). For example, a detection range and an analysis range of the surrounding sensor 31 are set in such a manner that surrounding information in a traveling direction when the own vehicle 11 travels along the planned trajectory 87 is selectively acquired.

A laser irradiation range and the like of the distance sensor such as a LiDAR sensor are set narrow in such a manner that depth information in the traveling direction indicated by the planned trajectory 87 is acquired. For example, an irradiation range of a sensor capable of performing 360-degree irradiation is set to be narrowed down to an irradiation range in a direction of 90 degrees to the left and right of the planned trajectory 87. Of course, the configuration is not limited thereto.

In the example illustrated in FIG. 15, control is performed in such a manner that the own vehicle 11 turns left along the planned trajectory 87. In this case, a detection range is narrowed down in such a manner that depth information regarding the left front of the own vehicle 11 can be acquired. This results in shortening the time necessary for scanning with laser and data acquisition. Further, it becomes possible to detect depth information focused on a necessary region, and thus to reduce an amount of data of the depth information.

Further, a point cloud obtained as depth information is analyzed focused on the traveling direction indicated by the planned trajectory 87, and this makes it possible to improve a speed of analytical processing. Likewise, when a specific object (a pedestrian, a bicycle, or an automobile) or the like is detected from image information detected by an image sensor, it is also possible to significantly reduce the processing time necessary to perform processing of detecting an object, such as a window search, by narrowing down the angle of view or cutting out an image in conformity to the traveling direction.

The cost map 86 is updated on the basis of a newest piece of surrounding information (Step 203). For example, it is assumed that the obstacle 81 has been detected as a result of analyzing surrounding information. In this case, a movement cost of a grid cell 88 corresponding to a position in which the obstacle 81 has been detected is overwritten with a larger value.

FIG. 16 is a schematic diagram illustrating an example of the updated movement plan. In FIG. 16, a parked vehicle 81b is detected ahead of the own vehicle 11 that turns left at the intersection 72. In this case, a high movement cost is set for a location in which there exists the parked vehicle 81b, and the cost map 86 is overwritten. Accordingly, the cost map 86 is updated to a newest state using surrounding information. Note that the cost map 86 is not updated when the obstacle 81 or the like is not detected.

A difference between the cost map 86 before being updated and the cost map 86 after being updated is calculated (Step 204). The difference between the cost maps 86 is a difference in a movement cost between before and after the update, and is calculated for each grid cell 88. For example, the grid cell 88 in which the obstacle 81 or the like has been detected exhibits a large difference, and the grid cell 88 in which the obstacle 81 or the like has not been detected exhibits almost no difference. Note that a method of calculating a difference in the cost map 86 is not limited.

it is determined, on the basis of the calculated difference, whether to discard the planned trajectory 87 (Step 205). For example, when the difference is small on the entire map (when there is a small change in a movement cost), it is determined that the planned trajectory 87 is not to be discarded, and the movement control using the planned trajectory 87 continues to be performed. On the other hand, when a large difference has been detected on the entire map, it is determined that there has been a significant change in a traffic state in the anticipation region 70 and that the planned trajectory 87 is to be discarded.

Further, for example, processing of comparing differences focused on a region surrounding the planned trajectory 87, may be performed. This makes it possible to promptly detect an obstacle or the like that intercepts the planned trajectory 87, and this results in an improvement in a processing speed. Moreover, processing of determining whether to discard the planned trajectory 87 is not limited, and, for example, matching processing using machine learning or the like, any threshold processing, or the like may be used.

When it has been determined that the planned trajectory 87 is not to be discarded (No in Step 205), the planned trajectory 87 of a region in which the difference has occurred is updated (Step 206). In the example illustrated in FIG. 16, there is an increase in a movement cost in grid cells 88a and 88b surrounding the parked vehicle 81b since the parked vehicle 81b has been detected ahead of the own vehicle 11 that has turned left. With respect to the region in which there has been a change (difference) in a movement cost, the planned trajectory 87 is recalculated on the basis of the updated cost map 86.

For example, as illustrated in FIG. 16, the planned trajectory 87 is updated in such a manner that the planned trajectory 87 passes through a grid cell 88 of a movement cost slightly higher than that of a grid cell 88 through which the original planned trajectory (a dotted line) passes. Accordingly, it is possible to sufficiently reduce the time necessary to recalculate the planned trajectory 87 by locally updating the planned trajectory 87 focused on a region in which a difference has occurred. Further, it is also possible to flexibly deal with a newly appearing obstacle 81 or the like.

The movement of the automobile 10 (the own vehicle 11) is controlled in such a manner that the automobile 10 passes through the updated planned trajectory 87 (Step 208). For example, the movement control unit 54 controls the steering apparatus 40, the braking apparatus 41, the vehicle body acceleration apparatus 42, and the like in such a manner that the own vehicle 11 moves along the planned trajectory 87. This results in achieving autonomous driving in the anticipation region 70.

Further, when it has been determined that the planned trajectory 87 is to be discarded (Yes in Step 205), a trajectory for movement of the own vehicle 11 is newly calculated using the updated cost map 86 (Step 207). For example, a trajectory is searched for on the updated cost map 86 using a search algorithm such as an A*algorithm, and a new trajectory is calculated. Of course, processing of searching for a trajectory using machine learning or the like may be performed. Note that the calculation of a trajectory is not limited to using the updated cost map 86, and, for example, a newly calculated cost map 86 or the like may be used.

When a new trajectory is calculated, the movement of the automobile 10 is controlled in such a manner that the automobile 10 passes through the new trajectory. This makes it possible to cause the automobile 10 to travel safely even when there is a great change in a traffic state in the anticipation region 70.

[Detection of Tentative Region]

A method of detecting a tentative region that is a region in which a complicated traffic state has temporarily occurred is described below.

In the present embodiment, a tentative region is detected by the server apparatus 21 on the basis of pieces of movement information of the automobile 10 that are accumulated in the database 22. Pieces of movement information are constantly uploaded to the database 22 by a plurality of automobiles 10. This makes it possible to analyze a state such as where each automobile 10 is traveling, or how long each automobile 10 has stayed in a certain location.

For example, traffic density in an arbitrary location is calculated by the server apparatus 21. Here, the traffic density is the number of automobiles 10 having traveled in a certain location per unit time. For example, an average traffic density (a normal traffic density) is calculated by setting a circle that has a predetermined radius (about 20 m) and is centered on a latitude and longitude of a location of interest and by analyzing an average of the number of vehicles having passed through the circle per unit time. Note that the average traffic density may be calculated by time of day including morning, day time, evening, and late at night.

When a region in which a complicated traffic state has occurred is detected, movement information of the automobile 10 having passed through a location of interest (a circle of a predetermined radius) at least 30 minutes before a start of detection, is extracted from the database 22. Then, an average traffic density (a most recent traffic density) of the automobile 10 having passed through the location of interest during 30 minutes is calculated on the basis of the extracted movement information. Note that a time of day of passage of the automobile 10, and the like that are used to calculate the most recent traffic density are not limited, and may be set as appropriate.

The server apparatus 21 determines whether the most recent traffic density is greater than a traffic density threshold set in advance. The traffic density threshold is set depending on a normal traffic density of a location of interest, and is typically set to a value that is equal to or greater than a normal traffic density at an intersection or the like. For example, the traffic density threshold is set low for a location with light traffic of the automobile 10 or the like coming and going, and is set high for a location with heavy traffic of the automobile 10 or the like coming and going. In the present embodiment, the traffic density threshold corresponds to a first threshold.

For example, when the most recent traffic density of the location of interest is greater than the traffic density threshold, it is determined that a complicated traffic state has temporarily occurred in the location of interest, and thus a region including the location of interest is set to be a tentative region. In other words, the tentative region is a region in which the traffic density of the automobile 10 is greater than the traffic density threshold.

As described above, a region in which the traffic density is equal to or greater than that of an intersection or the like and has significantly increased for a short period of time, is set to be a tentative region. This makes it possible to accurately detect a location or the like that has rapidly become congested. Note that a method of setting the traffic density threshold is not limited, and, for example, the traffic density threshold may be set as appropriate in such a manner that a temporary change in traffic volume in a location of interest can be detected.

Further, on the basis of the time (control processing time) it takes the automobile 10 to perform movement control, the server apparatus 21 detects a region in which a complicated traffic state has occurred. For example, the control processing time is a time necessary for the automobile 10 to acquire surrounding information, calculate a trajectory and the like, and perform movement control. For example, the control processing time is measured for each passage point 66 of the automobile 10, and the measured control processing times are accumulated in the database 22 as movement information of the automobile 10.

For example, an average of the control processing times (a normal processing time) of the automobile 10 passing through a location of interest is calculated by the server apparatus 21. The average processing time can also be considered a processing time normally necessary to travel in a location of interest. In order to detect a tentative region, pieces of movement information of the automobiles 10 having passed through a location of interest at least 30 minutes before the time of starting detection, are extracted, and an average of the control processing times (a most recent processing time) of these automobiles 10 is calculated. Note that a time of day of passage of the automobile 10, and the like that are used to calculate the control processing time are not limited, and may be set as appropriate.

The server apparatus 21 determines whether the most recent processing time is greater than a processing time threshold set in advance. The processing time threshold is typically set to a value greater than a normal processing time of a location of interest. A method of setting the processing time threshold is not limited, and the processing time threshold may be set as appropriate in such a manner that a tentative region can be detected with a desired degree of accuracy. In the present embodiment, the processing time threshold corresponds to a second threshold.

For example, when the most recent processing time of the location of interest is greater than the processing time threshold, there may be an increase in load with respect to control processing performed upon passing through the location of interest. In this case, it is determined that a complicated traffic state has temporarily occurred in the location of interest, and thus a region including the location of interest is set to be a tentative region. Thus, the tentative region is a region in which the time necessary for movement control of the automobile 10 is greater than the processing time threshold.

This makes it possible to accurately detect a location or the like that has rapidly become congested. Further, not only due to a backup of the automobiles 10, but also in a location with a heavy pedestrian traffic due to a festival or the like, there may be an increase in, for example, the processing time necessary for control of the automobile 10. It is also possible to set such a location to be a tentative region since a complicated traffic state has temporarily occurred in the location.

As described above, by setting, to be an anticipation region, a region (a tentative region) in which a complicated traffic state has temporarily occurred, it is possible to calculate the planned trajectory 87 and the like in advance even when the automobile 10 passes through a location in which there is a traffic disturbance due to an unexpected accident. This results in being able to promptly determine a traveling direction, a traveling speed, and the like of the automobile 10 and to move the automobile 10 properly.

As described above, in the control unit 50 according to the present embodiment, it is determined whether the anticipation region 70 in which a specific traffic state is anticipated exists on the planned route 62 of the own vehicle 11. When there exists the anticipation region 70 on the planned route 62, a movement plan of the own vehicle 11 in the anticipation region 70 is calculated on the basis of movement information of another vehicle 12 having passed through the anticipation region 70. The use of a movement plan makes it possible to promptly determine a traveling direction, a traveling speed, and the like of the own vehicle 11 and to move the own vehicle 11 smoothly.

A method of determining, for example, a trajectory along which an automobile will move, using information regarding surroundings of a current location of the automobile, is considered a method of controlling movement of the automobile. In this method, it is necessary to perform various processes including analyzing pieces of information from various sensors, recognizing a state surrounding a vehicle, putting together a result of the recognition, understanding a surrounding environment in the form of an obstacle occupancy map, and searching for a route on the map. For example, when a complicated traffic state is encountered, there may exist a plurality of dynamic obstacles, and a large number of static obstacles, such as a parked vehicle, that is not included in map data, and thus there may be an increase in the time necessary for respective processes to be performed for movement control. Further, an increase in the processing time may result in, for example, a time delay in control of an automobile and an unavoidable vehicle stop.

In the present embodiment, with respect to the anticipation region 70 determined to be on the planned route 62 of the own vehicle 11, a movement plan used to move the anticipation region 70 is calculated in advance by the movement plan calculating unit 58. Further, the movement plan is calculated on the basis of surrounding information of another vehicle 12 having passed through the anticipation region 70 immediately before the own vehicle 11 arrives at the anticipation region 70.

This makes it possible to promptly perform processing necessary for movement control by moving the own vehicle 11 on the basis of a movement plan, even when the own vehicle 11 passes through a region, such as the intersection 72, in which a complicated traffic state is anticipated. Thus, it is possible to suppress, to a satisfactory extent, an increase in the processing time necessary to perform movement control, and thus to avoid, for example, a delay in control and a following vehicle stop to a satisfactory extent.

Further, the use of surrounding information of another vehicle 12 having passed through the anticipation region 70 immediately before the own vehicle 11 arrives at the anticipation region 70 makes it possible to calculate a movement plan that simulates positions of a parked vehicle, an obstacle, and the like in the anticipation region 70. This makes it possible to generate the planned trajectory 87 that avoids the position of the obstacle 81 in advance, and thus to control movement of the own vehicle 11 naturally.

A change in a traffic state when the own vehicle 11 actually arrives at the anticipation region 70 is considered to be caused primarily due to a dynamic obstacle (such as a pedestrian, a bicycle, and another vehicle). Thus, it is possible to narrow a detection range or the like of the surrounding sensor down to, for example, a traveling direction indicated by the planned trajectory 87. This results in being able to sufficiently reduce the time necessary to recognize surrounding information of the own vehicle 11, the time necessary to perform subsequent processes, and the like. Consequently, it is possible to properly issue, for example, a control signal used to control the own vehicle 11 in real time, and to cause the own vehicle to travel safely.

Further, in the present embodiment, it is also possible to calculate a movement plan for a region (a tentative region) in which a complicated traffic state has temporarily occurred. As described above, even when unexpected congestion or the like is encountered, processing of calculating a trajectory that takes time to calculate, and the like can be performed in advance. This makes it possible to suppress the occurrence of, for example, emergency stop to a satisfactory extent, and to control the own vehicle 11 properly.

### OTHER EMBODIMENTS

The present technology is not limited to the embodiments described above, and various other embodiments are possible.

In the embodiments described above, it is determined, referring to the anticipation region database 55 in which the anticipation region 70 is stored, whether the anticipation region 70 exists on the planned route 62 of the automobile 10. The determination is not limited thereto, and, for example, it may be determined whether there exists the anticipation region such as an intersection on the basis of information such as a road map.

For example, on the basis of, for example, map data (see FIG. 4) used to generate a planned route, the determination unit may detect, as appropriate, a region, such as an intersection, a junction, and a fork, in which a complicated traffic state is anticipated. In this case, it is determined whether the detected intersection or the like exists on the planned route. It is possible to acquire movement information of another automobile having passed through the intersection determined by the determination unit, on the basis of position information of the determined intersection. Such a configuration may be adopted.

In the descriptions above, the anticipation region database is provided to the automobile, as illustrated in FIG. 7. The configuration is not limited thereto, and, for example, the anticipation region database may be provided in the network. In this case, an own vehicle accesses the anticipation region database via the server apparatus connected to each of the own vehicle and another vehicle in such a manner that the server apparatus is capable of communicating with the own vehicle and the other vehicle via the network.

The determination unit acquires anticipation region information from the server apparatus, and determines whether the anticipation region exists on the planned route on the basis of the acquired anticipation region information. The provision of the anticipation region database in the network makes it possible to easily perform, for example, a new addition of or deletion of an anticipation region (such as an intersection or a tentative region). This results in being able to constantly acquire a newest piece of anticipation region information, and to determine an anticipation region with a high degree of accuracy.

In the embodiments described above, a movement plan (a contrast map and a planned trajectory) is generated by the movement planning unit (the control unit) included in an automobile, the movement plan being used to control movement of a vehicle that includes the movement planning unit. The configuration is not limited thereto, and, for example, the server apparatus connected to the network may include a function of generating a movement plan or the like.

For example, movement information including a current location, a planned route, surrounding information, and the like of an automobile that is a movement control target (a target automobile), is transmitted to the server apparatus from the target automobile. The server apparatus determines whether an anticipation region exists on the planned route on the basis of current information of the target automobile. Further, with respect to an anticipation region determined to be on the planned route, the server apparatus calculates, in advance, a movement plan in conformity to the planned route of the target automobile, and transmits the calculated movement plan to the target automobile in synchronization with an expected arrival time of the target automobile. Then, control of movement of the target automobile including obstacle avoidance in the anticipation region is performed, with the movement plan calculated by the server apparatus being set to be a target.

Even when a movement plan is generated by the server apparatus, the use of the movement plan makes it possible to promptly determine a traveling direction, a traveling speed, and the like at an intersection or the like in which a complicated traffic state is anticipated. Further, the configuration is not limited to calculating a movement plan using a specific server apparatus, and parallel computation may be performed using a plurality of computers connected to a network. This makes it possible to significantly reduce the processing time and the like necessary to calculate a movement plan.

As described above, when a computer (the control unit) installed in an automobile and another computer (the server apparatus) capable of communication via a network or the like work in conjunction with each other, the information processing method and the program according to the present technology are executed, and this makes it possible to configure the information processing apparatus according to the present technology.

That is, the information processing method and the program according to the present technology may be executed not only in a computer system configured by a single computer but also in a computer system in which a plurality of computers operates cooperatively. Note that, in the present disclosure, the system means an aggregate of a plurality of components (apparatus, module (parts), and the like) and it does not matter whether all the components are housed in the same casing. Therefore, a plurality of apparatuses housed in separate casings and connected to one another via a network and a single apparatus having a plurality of modules housed in a single casing are both the system.

The execution of the information processing method and the program according to the present technology by the computer system includes, for example, both of a case where the determination of whether there exists an anticipation region on a planned route, the calculation of a movement plan, and the like are executed by a single computer and a case where those processes are executed by different computers. Further, the execution of the respective processes by a predetermined computer includes causing the other computer to perform some of or all of those processes and acquiring results thereof.

That is, the information processing method and the program according to the present technology are also applicable to a cloud computing configuration in which one function is shared and cooperatively processed by a plurality of apparatuses via a network.

In the embodiments described above, information regarding a passage point through which an automobile has passed, surrounding information at the passage point, and the like are exemplified as movement information related to movement of the automobile. The present technology is not limited thereto, and any information related to movement of the automobile or the like may be used as the movement information.

In the embodiments described above, each of the plurality of automobiles included in the movement control system uploads movement information. Next, movement information related to movement of another vehicle that is uploaded by the other vehicle is acquired for controlling movement of an own vehicle, and a movement plan of the own vehicle is generated. The present technology is not limited thereto, and, for example, movement information uploaded by another vehicle may be used when an automobile that does not upload its own movement information is a control target.

In the embodiments described above, the automobile has been described as an example of a mobile object. However, the present technology is applicable to any type of mobile object and the like. For example, an aerial drone capable of autonomous flight or the like is considered as the mobile object. For example, the aerial drone includes the GPS sensor, the surrounding sensor, or the like, and uploads movement information related to its movement (flight) and the like to the database. As a result, the database accumulates information regarding three-dimensional flight trajectories of a plurality of aerial drones at various locations or the like.

For example, the use of such information makes it possible to calculate a flight plan in advance depending on a traffic state at a point on a route, the point including a landing or takeoff point in which a complicated traffic state is anticipated, and a point through which it is difficult to pass due to an obstacle or the like. Accordingly, even when a complicated traffic state is encountered, it is possible to reduce the processing time for movement control and to control flight smoothly depending on an actual flight environment or the like.

In addition, the technology according to the present disclosure can be applied to various products. For example, the technology according to the present disclosure may be realized as an apparatus installed in any kind of mobile object such as vehicles, electric vehicles, hybrid electric vehicles, motorcycles, bicycles, personal transporters, airplanes, drones, ships, robots, heavy equipment, agricultural machinery (tractors), and the like.

Out of the feature parts according to the present technology described above, at least two feature parts can be combined. That is, the various feature parts described in the embodiments may be arbitrarily combined irrespective of the embodiments. Further, various effects described above are merely examples and are not limitative, and other effects may be exerted.

Note that the present technology may also be configured as below.

(1) An information processing apparatus including:

a determination unit that determines whether an anticipation region exists on a planned route of a target mobile object that is a control target, the anticipation region being a region in which a specific traffic state is anticipated; and

a calculation unit that calculates a movement plan of the target mobile object with respect to the anticipation region determined to be on the planned route, on the basis of movement information related to movement of another mobile object having passed through the anticipation region.

(2) The information processing apparatus according to (1), in which

the specific traffic state is a complicated traffic state.

(3) The information processing apparatus according to (1) or (2), in which

the movement plan includes a cost map related to a movement cost in the anticipation region, and a planned trajectory of the target mobile object that is calculated on the basis of the cost map.

(4) The information processing apparatus according to one of (1) to (3), in which

the calculation unit calculates the movement plan at least a predetermined time before an expected arrival time that is a time of arrival of the target mobile object at the anticipation region.

(5) The information processing apparatus according to any one of (1) to (4), further including an acquisition unit that acquires the movement information of the other mobile object on the basis of a passage time that is a time of passage of the other mobile object through the anticipation region, the movement information of the other mobile object being used to calculate the movement plan.
(6) The information processing apparatus according to any one of (1) to (5), in which

the movement information includes information regarding a passage point of the other mobile object in the anticipation region, and surrounding information of the other mobile object that is detected at a timing at which the other mobile object passes through the passage point.

(7) The information processing apparatus according to (6), in which

the calculation unit calculates a first map on the basis of the surrounding information of the other mobile object, the first map indicating a position of an obstacle in the anticipation region at the timing at which the other mobile object passes through the passage point.

(8) The information processing apparatus according to (7), in which

the calculation unit calculates a second map on the basis of the first map, the second map indicating behavior of the obstacle for a period of time during which the other mobile object passes through the anticipation region.

(9) The information processing apparatus according to (8), in which

the calculation unit calculates a cost map related to a movement cost in the anticipation region on the basis of the second map.

(10) The information processing apparatus according to any one of (3) to (9), further including an update unit that updates the cost map on the basis of surrounding information of the target mobile object when the target mobile object enters the anticipation region.
(11) The information processing apparatus according to (10), in which

on the basis of the planned trajectory, the update unit sets at least one of a detection range or an analysis range of the surrounding information of the target mobile object.

(12) The information processing apparatus according to (10) or (11), in which

the update unit calculates a difference between the cost map before being updated and the cost map after being updated, and updates the planned trajectory of a region in which the difference has occurred.

(13) The information processing apparatus according to (12), in which

on the basis of the difference, the update unit determines whether to discard the planned trajectory, and

when the update unit determines that the planned trajectory is to be discarded, the update unit newly calculates a trajectory used to move the target mobile object.

(14) The information processing apparatus according to any one of (1) to (13), in which

the anticipation region includes at least one of an intersection, a junction, or a fork.

(15) The information processing apparatus according to any one of (1) to (14), in which

the anticipation region includes a tentative region that is a region in which a complicated traffic state has temporarily occurred.

(16) The information processing apparatus according to any one of (1) to (15), in which

the determination unit acquires anticipation region information related to the anticipation region from a server that is connected to each of the target mobile object and the other mobile object in such a manner that the server is capable of communicating with the target mobile object and the other mobile object via a network, and determines whether the anticipation region exists on the planned route on the basis of the acquired anticipation region information.

(17) A vehicle including:

a determination unit that determines whether an anticipation region exists on a planned route of an own vehicle that is a control target, the anticipation region being a region in which a specific traffic state is anticipated;

a calculation unit that calculates a movement plan of the own vehicle with respect to the anticipation region determined to be on the planned route, on the basis of movement information related to movement of another vehicle having passed through the anticipation region; and

a movement control unit that controls movement of the own vehicle in the anticipation region on the basis of the generated movement plan.

(18) A mobile object including:

a determination unit that determines whether an anticipation region exists on a planned route of a mobile object that is a control target, the anticipation region being a region in which a specific traffic state is anticipated;

a calculation unit that calculates a movement plan of the mobile object of the control target with respect to the anticipation region determined to be on the planned route, on the basis of movement information related to movement of another mobile object having passed through the anticipation region; and

a movement control unit that controls, on the basis of the generated movement plan, movement of the mobile object of the control target in the anticipation region.

(19) An information processing method that is performed by a computer system, the information processing method including:

determining whether an anticipation region exists on a planned route of a target mobile object that is a control target, the anticipation region being a region in which a specific traffic state is anticipated; and

calculating a movement plan of the target mobile object with respect to the anticipation region determined to be on the planned route, on the basis of movement information related to movement of another mobile object having passed through the anticipation region.

(20) A program that causes a computer system to perform a process including:

determining whether an anticipation region exists on a planned route of a target mobile object that is a control target, the anticipation region being a region in which a specific traffic state is anticipated; and

calculating a movement plan of the target mobile object with respect to the anticipation region determined to be on the planned route, on the basis of movement information related to movement of another mobile object having passed through the anticipation region.

### REFERENCE SIGNS LIST

10 automobile
11 own vehicle
12, 12a and 12b another vehicle
21 server apparatus
22 database
50 control unit
54 movement control unit
55 anticipation region database
56 determination unit
57 acquisition unit
58 movement plan calculating unit
62 planned route
66 passage point
70 anticipation region
86 cost map
87 planned trajectory
100 movement control system

1. An information processing apparatus comprising:
a determination unit that determines whether an anticipation region exists on a planned route of a target mobile object that is a control target, the anticipation region being a region in which a specific traffic state is anticipated; and
a calculation unit that calculates a movement plan of the target mobile object with respect to the anticipation region determined to be on the planned route, on a basis of movement information related to movement of another mobile object having passed through the anticipation region.

2. The information processing apparatus according to claim 1, wherein
the specific traffic state is a complicated traffic state.

3. The information processing apparatus according to claim 1, wherein
the movement plan includes a cost map related to a movement cost in the anticipation region, and a planned trajectory of the target mobile object that is calculated on a basis of the cost map.

4. The information processing apparatus according to claim 1, wherein
the calculation unit calculates the movement plan at least a predetermined time before an expected arrival time that is a time of arrival of the target mobile object at the anticipation region.

5. The information processing apparatus according to claim 1, further comprising an acquisition unit that acquires the movement information of the other mobile object on a basis of a passage time that is a time of passage of the other mobile object through the anticipation region, the movement information of the other mobile object being used to calculate the movement plan.

6. The information processing apparatus according to claim 1, wherein
the movement information includes information regarding a passage point of the other mobile object in the anticipation region, and surrounding information of the other mobile object that is detected at a timing at which the other mobile object passes through the passage point.

7. The information processing apparatus according to claim 6, wherein
the calculation unit calculates a first map on a basis of the surrounding information of the other mobile object, the first map indicating a position of an obstacle in the anticipation region at the timing at which the other mobile object passes through the passage point.

8. The information processing apparatus according to claim 7, wherein
the calculation unit calculates a second map on a basis of the first map, the second map indicating behavior of the obstacle for a period of time during which the other mobile object passes through the anticipation region.

9. The information processing apparatus according to claim 8, wherein
the calculation unit calculates a cost map related to a movement cost in the anticipation region on a basis of the second map.

10. The information processing apparatus according to claim 3, further comprising an update unit that updates the cost map on a basis of surrounding information of the target mobile object when the target mobile object enters the anticipation region.

11. The information processing apparatus according to claim 10, wherein
on a basis of the planned trajectory, the update unit sets at least one of a detection range or an analysis range of the surrounding information of the target mobile object.

12. The information processing apparatus according to claim 10, wherein
the update unit calculates a difference between the cost map before being updated and the cost map after being updated, and updates the planned trajectory of a region in which the difference has occurred.

13. The information processing apparatus according to claim 12, wherein
on a basis of the difference, the update unit determines whether to discard the planned trajectory, and
when the update unit determines that the planned trajectory is to be discarded, the update unit newly calculates a trajectory used to move the target mobile object.

14. The information processing apparatus according to claim 1, wherein
the anticipation region includes at least one of an intersection, a junction, or a fork.

15. The information processing apparatus according to claim 1, wherein
the anticipation region includes a tentative region that is a region in which a complicated traffic state has temporarily occurred.

16. The information processing apparatus according to claim 1, wherein
the determination unit acquires anticipation region information related to the anticipation region from a server that is connected to each of the target mobile object and the other mobile object in such a manner that the server is capable of communicating with the target mobile object and the other mobile object via a network, and determines whether the anticipation region exists on the planned route on a basis of the acquired anticipation region information.

17. A vehicle comprising:
a determination unit that determines whether an anticipation region exists on a planned route of an own vehicle that is a control target, the anticipation region being a region in which a specific traffic state is anticipated;
a calculation unit that calculates a movement plan of the own vehicle with respect to the anticipation region determined to be on the planned route, on a basis of movement information related to movement of another vehicle having passed through the anticipation region; and
a movement control unit that controls movement of the own vehicle in the anticipation region on a basis of the generated movement plan.

18. A mobile object comprising:
a determination unit that determines whether an anticipation region exists on a planned route of a mobile object that is a control target, the anticipation region being a region in which a specific traffic state is anticipated;
a calculation unit that calculates a movement plan of the mobile object of the control target with respect to the anticipation region determined to be on the planned route, on a basis of movement information related to movement of another mobile object having passed through the anticipation region; and
a movement control unit that controls, on a basis of the generated movement plan, movement of the mobile object of the control target in the anticipation region.

19. An information processing method that is performed by a computer system, the information processing method comprising:
determining whether an anticipation region exists on a planned route of a target mobile object that is a control target, the anticipation region being a region in which a specific traffic state is anticipated; and
calculating a movement plan of the target mobile object with respect to the anticipation region determined to be on the planned route, on a basis of movement information related to movement of another mobile object having passed through the anticipation region.

20. A program that causes a computer system to perform a process comprising:
determining whether an anticipation region exists on a planned route of a target mobile object that is a control target, the anticipation region being a region in which a specific traffic state is anticipated; and
calculating a movement plan of the target mobile object with respect to the anticipation region determined to be on the planned route, on a basis of movement information related to movement of another mobile object having passed through the anticipation region.
